(19) United States
(12) Patent Application Publication
(10) Pub. No.: US 2026/0076305 A1
(43) Pub. Date: Mar. 19, 2026

(54) DUAL-MODE SWITCHING PLATFORM INTEGRATING DRY FRUIT DETECTION AND LEAF SCREENING FRUIT COLLECTION AND ITS OPERATION METHOD

(71) Applicant: NANJING FORESTRY UNIVERSITY, Nanjing (CN)

(72) Inventors: Huichun ZHANG, Nanjing (CN); Liming BIAN, Nanjing (CN); Lei ZHOU, Nanjing (CN); Hongping ZHOU, Nanjing (CN); Ji QI, Nanjing (CN)

(73) Assignee: NANJING FORESTRY UNIVERSITY, Nanjing, JS (CN)

(21) Appl. No.: 19/399,698

(22) Filed: Nov. 25, 2025

(30) Foreign Application Priority Data
Jul. 22, 2025 (CN) 2025110103271

(51) Int. Cl. A01D 46/30; G06V 20/68; H04N 23/695

(52) U.S. Cl. CPC A01D 46/30; G06V 20/68; H04N 23/695

(57) ABSTRACT

The present invention discloses an integrated platform of dual-mode switching dry fruit detection and screening and a working method thereof. The platform comprises a frame body, a left detection picking mechanism, a right detection picking mechanism, a left screening leaf collecting fruit mechanism, a right screening leaf collecting fruit mechanism, a conveying mechanism, and a fruit collecting box. According to the present invention, a “phenotype monitoring-comb harvesting” dual-mode collaborative architecture is adopted, and automatic detection of fruit ripeness is achieved via left and right detection picking mechanisms; non-destructive and precise separation of fruit is achieved via a flexible comb brush technique and a dynamic mode switching mechanism; the height and inclination angle of fruit collecting are adaptively adjusted via an umbrella-type electric telescopic rod, thereby effectively avoiding the hybrid of fruit and leaves.

### CROSS REFERENCE OF RELATED APPLICATION

This patent application claims the benefit of and priority to Chinese Patent Application No. 202511010327.1, filed with the China National Intellectual Property Administration on Jul. 22, 2025, the disclosure of which is incorporated by reference herein in its entirety as part of the present application.

### FIELD OF THE INVENTION

The present invention belongs to the technical field of forest fruit harvesting machinery, specifically relates to an integrated platform for a dual-mode switching dry fruit detection and screening leaf collecting fruit and a working method therefor, which is applicable to the mechanized harvesting operation of low dry fruit economic forests in the environment of dwarfing densely planted orchards.

### BACKGROUND OF THE INVENTION

As a high value-added economic crop, dry fruit occupy strategic locations in the agricultural forestry production and global supply chain. Nut products such as walnut, chestnut, pecan and Hawaii fruit have both nutritional value and outlet creation function, which is of great significance for promoting economic development, achieving rural shaoxing and increasing farmer income. However, the current dry fruit harvesting link faces a severe mechanized bottleneck: the mainstream operation mode is still dependent on manual or simple mechanical equipment, and there is a core problem of low recovery efficiency, high labor intensity, high fruit damage rate, etc. This not only increases production costs, but more restricts the implementation of modern agricultural forestry intensive development targets.

In terms of fruit ripeness monitoring, traditional methods mainly rely on manual experience determination or simple physical measurement tools, and there are limitations such as poor monitoring timeliness, low efficiency, poor accuracy, etc. and it is difficult to meet the requirements of modern orchard for precise and intelligent management. Therefore, the development of an efficient and accurate fruit phenotype in-situ monitoring technology has become an urgent demand for industrial upgrade.

The existing mechanized dry fruit harvesting technology has significant limitations in practical applications: the vibrating recovery device is prone to structural damage to the tree trunk, and long-term use may affect the life of the fruit tree; although the airflow adsorption recovery system can reduce damage, the device has a complex structure, high manufacturing cost, and high maintenance difficulty, and is difficult to promote in the middle and small plantation The common defect of the existing recovery technology is the lack of adaptive capability on the difference of dry fruit varieties (such as fruit ripeness), resulting in unstable recovery quality, difficulty in tree body health and fruit integrity being difficult to take into account.

### SUMMARY OF THE INVENTION

The present invention provides a dual-mode switching platform integrating dry fruit detection and leaf screening fruit collection, and an operation method therefor. The platform uses a “phenotype monitoring-comb harvesting” dual-mode collaborative architecture, achieves automatic detection of fruit ripeness via left and right detection picking mechanisms, has high efficiency and high accuracy; a non-destructive and precise separation of fruit is achieved via a flexible comb brush technology and a dynamic mode switching mechanism. The left and right screening leaf collecting fruit mechanisms adaptively adjust the height and inclination angle of a collection via an umbrella-type electric telescopic rod, thereby effectively avoiding fruit and leaf mixing, and further improving the recovery efficiency; the labor intensity is low, and the device is simple in structure, and is suitable for dwarf dense orchard and economic forest scenarios.

In order to achieve the above technical objective, the following technical solution is adopted in the present invention.

A dual-mode switching platform integrating dry fruit detection and leaf screening fruit collection, comprising a frame body 1, a left detection picking mechanism 2A, a right detection picking mechanism 2B, a left screening leaf collecting fruit mechanism 3A, a right screening leaf collecting fruit mechanism 3B, a conveying mechanism 5, and a fruit collecting box 4; the fruit collection box 4 is mounted on the frame body 1, a left side of the fruit collection box 4 is connected to the left detection picking mechanism 2A via a left rotation driving mechanism, and a right side of the fruit collection box 4 is connected to a right detection picking mechanism 2B via a right rotation driving mechanism; the rotation driving mechanism is used for driving the left detection picking mechanism 2A to rotate, and the right rotation driving mechanism is used for driving the right detection picking mechanism 2B to rotate;
the left detection picking mechanism 2A and the right detection picking mechanism 2B have the same structure and are symmetrically arranged, each comprising an upper comb brush chassis 201, a lower comb brush chassis 202, and a dual-mode drive monitoring comb module; the dual-mode drive monitoring comb module comprises a module mounting frame, a fruit monitoring module and a comb brush module; the lower surface of the upper comb brush chassis 201 and the upper surface of the lower comb brush chassis 202 are each provided with a guide rail 204; the module mounting frame comprises an upper mounting plate 205, a lower mounting plate 206, and a spindle 207; the upper mounting plate 205 is connected to the upper portion of the spindle 207; the lower mounting plate 206 is connected to the lower portion of the spindle 207; both the top and the bottom of the spindle 207 are rotatably connected to a trolley plate 208; the trolley plate 208 is slidably connected to the guide rail 204; the trolley plate 208 is provided with a walking driving mechanism for driving the trolley plate 208 to move along the guide rail 204, and a spindle rotation driving mechanism for driving the spindle 207 to rotate; the fruit monitoring module is arranged between one end of the upper mounting plate 205 and one end of the lower mounting plate 206, and the comb brush module is arranged between the other end of the upper mounting plate 205 and the other end of the lower mounting plate 206; the fruit monitoring module is used for collecting images of fruit on the fruit tree 7 and detecting the ripeness of the fruit, and the comb brush module is used for picking fruit on the fruit tree 7;
the lower comb brush chassis 202 of the left detection picking mechanism 2A is provided with a left screening leaf collecting fruit mechanism 3A, and the lower comb brush chassis 202 of the right detection picking mechanism 2B is provided with a right screening leaf collecting fruit mechanism 3B; the left screening leaf collecting fruit mechanism 3A and the right screening leaf collecting fruit mechanism 3B have the same structure and are symmetrically arranged, each comprising a plurality of umbrella-type electric telescopic rods 301, the umbrella-type electric telescopic rods 301 being obliquely and fixedly connected to the bottom of the lower comb-brush chassis 202; one end of the conveying mechanism 5 is located between the left screening leaf collecting fruit mechanism 3A and the right screening leaf collecting fruit mechanism 3B structure and is located below the two lower comb brush chassis 202, and the other end extends upwards to above the inner side of the fruit collecting box 4; the bottom ends of the umbrella-type electric telescopic rods 301 in the left screening leaf collecting fruit mechanism 3A and the right screening leaf collecting fruit mechanism 3B are both used for attaching trunk surfaces and collecting and rolling the falling fruit to the conveying mechanism 5, and the conveying mechanism 5 is used for conveying the fruit to the fruit collection box 4 in the interior of the fruit collection box 4.

According to the dual-mode switching platform integrating dry fruit detection and leaf screening fruit collection, a notch 401 is formed in the middle of the front side surface of the fruit collection box 4, and the other end of the conveying mechanism 5 extends from the notch 401 to the inner side of the fruit collection box 4; the left detection picking mechanism 2A and the left screening leaf collecting fruit mechanism 3A are located on the left side of the notch 401, and the right detection picking mechanism 2B and the right screening leaf collecting fruit mechanism 3B are located on the right side of the notch 401.

According to the dual-mode switching platform integrating dry fruit detection and leaf screening fruit collection, the left rotation driving mechanism and the right rotation driving mechanism are respectively located on left and right sides of the notch 401, and structures of the left rotation driving mechanism and the right rotation driving mechanism are the same, and both include an upper hydraulic telescopic rod 402 and a lower hydraulic telescopic rod 403;
a left support frame 404 extending upwards and a right support frame 405 extending upwards are provided on the top of the front side surface of the fruit collection box 4;
the left support frame 404 is located above the left side of the notch 401, and the right support frame 405 is located above the right side of the notch 401;
the top of the left support frame 404 is rotatably connected to one end of the connection lug on the upper comb brush chassis 201 in the left detection picking mechanism 2A via the left L-shaped connection plate 406, and at the same time, the top of the left support frame 404 is rotatably connected to one end of the upper hydraulic telescopic rod 402, and the other end of the upper hydraulic telescopic rod 402 is rotatably connected to the other end of the connection lug on the upper comb brush chassis 201 in the left detection picking mechanism 2A;
the top of the right support frame 405 is rotatably connected to one end of the connection lug on the upper comb brush chassis 201 in the right detection picking mechanism 2B via the right L-shaped connection plate 407, and at the same time, the top of the right support frame 405 is rotatably connected to one end of the upper hydraulic telescopic rod 402, and the other end of the upper hydraulic telescopic rod 402 is rotatably connected to the other end of the connection lug on the upper comb brush chassis 201 in the right detection picking mechanism 2B;
the bottom of the front side of the fruit collection box 4 is provided with a left base 408 and a right base 409 extending forward, the left base 408 is located below the left side of the notch 401, and the right base 409 is located below the right side of the notch 401;
the left base 408 is rotatably connected to one end of the connection lug on the lower comb brush chassis 202 in the left detection picking mechanism 2A via the left fixed shaft 410, and at the same time, the bottom of the left side of the front side of the fruit collection box 4 is rotatably connected to one end of the lower hydraulic telescopic rod 403, and the other end of the lower hydraulic telescopic rod 403 is rotatably connected to the other end of the connection lug on the lower comb brush chassis 202 in the left detection picking mechanism 2A;
the right base 409 is rotatably connected to one end of the connection lug on the lower comb brush chassis 202 in the right detection picking mechanism 2B via the right fixed shaft 411, and at the same time, the bottom of the right side of the front side face of the fruit collection box 4 is rotatably connected to one end of the lower hydraulic telescopic rod 403, and the other end of the lower hydraulic telescopic rod 403 is rotatably connected to the other end of the connection lug on the lower comb brush chassis 202 in the right detection picking mechanism 2B.

According to the dual-mode switching platform integrating dry fruit detection and leaf screening fruit collection, both the upper comb brush chassis 201 and the lower comb brush chassis 202 are semicircular annular chassis, and the guide rail 204 are semicircular annular guide rail; the two upper hydraulic telescopic rods 402 are used for respectively driving one end of the two upper comb brush chassis 201 to be separated or closed, and the two lower hydraulic telescopic rods 403 are used for respectively driving one end of the two lower comb brush chassis 202 to be separated or closed.

According to the dual-mode switching platform integrating dry fruit detection and leaf screening fruit collection, the trolley plate 208 at the top of the spindle 207 and the trolley plate 208 at the bottom of the spindle 207 are rotatably connected with rollers 212 in rolling connection with the guide rail 204;
the trolley board 208 at the bottom of the spindle 207 is provided with a walking driving mechanism, the walking driving mechanism comprises a walking motor 209, a rack 210 and a gear 211, the rack 210 is connected to one side of the guide rail 204, the walking motor 209 is provided on the trolley board 208, the output of the walking motor 209 is connected to the gear 211, and the gear 211 meshes with the rack 210;
the trolley plate 208 at the top of the spindle 207 is provided with a spindle rotation driving mechanism, the spindle rotation driving mechanism comprises a transmission motor 213, a belt 214, a main pulley and a auxiliary pulley, the trolley plate 208 is provided with the transmission motor 213; the output end of the transmission motor 213 is connected to the main pulley, the outer circular surface of the spindle 207 is connected to the auxiliary pulley, the main pulley are in transmission connection with the auxiliary pulley via the belt 214.

According to the dual-mode switching platform integrating dry fruit detection and leaf screening fruit collection, the fruit monitoring module comprises a screw slider lifting mechanism 215, an imaging sensor 216 and a control box 221, the control box 221 is connected to the rear side surface of the fruit collection box 4, the imaging sensor 216 is connected to the slider in the screw slider lifting mechanism 215, the top of the screw slider lifting mechanism 215 is connected to one end of the upper mounting plate 205, the bottom of the screw slider lifting mechanism 215 is connected to one end of the lower mounting plate 206, both the screw slide lifting mechanism 215 and the imaging sensor 216 are electrically connected to the control box 221.

According to the dual-mode switching platform integrating dry fruit detection and leaf screening fruit collection, the comb brush module comprises a comb brush motor 217, a bevel gear system 218 and a comb brush shaft 219, the bottom of the comb brush shaft 219 is rotatably connected to the other end of the lower mounting plate 206, the top of the comb brush shaft 219 is rotatably connected to the other end of the upper mounting plate 205, the upper end of combing shaft 219 is connected to the output shaft of the comb brush motor 217 via the bevel gear system 218; the comb brush motor 217 is connected to the upper mounting plate 205; the comb brush motor 217 drives the comb brush shaft 219 to rotate via the bevel gear system 218, the comb brush shaft 219 is fixedly connected to a plurality of comb brush rods 220, and the surface of the comb brush rod 220 is provided with a plurality of protrusions 2201.

According to the dual-mode switching platform integrating dry fruit detection and leaf screening fruit collection, the bottom of the umbrella-type electric telescopic rod 301 is provided with a polyurethane buffer kit; the conveying mechanism 5 adopts an electric conveying mechanism; the conveying mechanism 5 is connected to the frame body 1 via the front support column 501, and to the bottom of the inner side of the fruit collection box 4 via the rear support column 502.

According to the dual-mode switching platform integrating dry fruit detection and leaf screening fruit collection, further comprising a power supply, the umbrella-type electric telescopic rod 301, the walking motor 209 of the walking driving mechanism, the transmission motor 213 of the spindle rotation driving mechanism, the comb brush motor 217 of the comb brush module and the electric conveying mechanism of the conveying mechanism 5 are all electrically connected to the control box 221; the control box 221 is further used for controlling the action of the upper hydraulic telescopic rod 402 and the lower hydraulic telescopic rod 403; the umbrella-type electric telescopic rod 301, the walking motor 209 of the walking driving mechanism, the transmission motor 213 of the spindle rotation driving mechanism, the screw slider lifting mechanism 215 of the fruit monitoring module, the imaging sensor 216 of the fruit monitoring module, the comb brush motor 217 of the comb brush module, the electric conveying mechanism of the conveying mechanism 5 and the control box 221 are both electrically connected to the power supply.

In order to achieve the above technical object, the present invention adopts another technical solution as follows.

An operation method based on the dual-mode switching platform integrating dry fruit detection and leaf screening fruit collection, comprising the following steps:
Step 1, the frame body 1 moves to the vicinity of the target fruit tree 7, the two upper hydraulic telescopic rods 402 and the two lower hydraulic telescopic rods 403 act together to drive the left detection picking mechanism 2A and the right detection picking mechanism 2B to close, that is, the two upper comb brush chassis 201 are driven to close and the two lower comb brush chassis 202 are closed, and the fruit tree 7 is located between the two upper comb brush chassis 201 and the two lower comb brush chassis 202; and at the same time, the umbrella-type electric telescopic rod 301 in the left screening leaf collecting fruit mechanism 3A and the right screening leaf collecting fruit mechanism 3B is started, so that the bottom end of the umbrella-type electric telescopic rod 301 is attached to the surface of the trunk;
Step 2, the left detection picking mechanism 2A and the right detection picking mechanism 2B respectively perform the following steps:
Step 2.1, starting the spindle rotation driving mechanism, the spindle rotation driving mechanism driving the spindle 207 to rotate, so that the imaging sensor 216 in the fruit monitoring module faces the fruit to be detected on the fruit tree 7;
Step 2.2, starting the screw slider lifting mechanism 215, the screw slider lifting mechanism 215 driving the imaging sensor 216 to move up and down;
Step 2.3, the imaging sensor 216 collects the fruit surface image of the fruit tree 7 during the up and down sensor's movement, and sends the image information to the control box 221 in real time; the control box 221 performs analysis processing according to the received image information to determine whether the fruit needs to be picked; if so, step 2.4 is executed; otherwise, step 2.6 is performed;
Step 2.4, the control box 221 controls the spindle rotation driving mechanism to act, the transmission motor 213 of the spindle rotation driving mechanism drives the spindle 207 to rotate via the belt 214 so that the comb brush module faces the fruit to be picked in the fruit tree 7;
Step 2.5, starting the comb brush module, the comb brush motor 217 in the comb brush module driving the comb brush shaft 219 to rotate via the bevel gear system 218, thereby achieving fruit picking; and the picked fruit is rolled onto the conveying mechanism 5 from the umbrella-type electric telescopic rod 301, and the conveying mechanism 5 conveys the fruit to the fruit collection box 4; after the number of times that the trolley plate 208 moves back and forth along the guide rail 204 reaches a preset number of times, the picking process is ended, otherwise step 2.6 is executed;
Step 2.6, starting the walking driving mechanism, the walking driving mechanism driving the spindle 207, the fruit monitoring module and the comb brush module moving a preset distance along the guide rail 204 via the trolley plate 208, and after the movement ends, if the imaging sensor 216 has facing the fruit to be detected on the fruit tree 7, returning to execute step 2.2; and if the imaging sensor 216 does not face the fruit to be detected on the fruit tree 7, returning to step 2.1.

The gap of the umbrella-type electric telescopic rod of the present invention is precisely set according to 0.6 to 0.8 times the minimum diameter of the target fruit, thereby achieving efficient automatic separation of fruit leaves. The end of the umbrella-type electric telescopic rod is in contact with the trunk via the polyurethane buffer kit covered by the flexible buffer material, and has a curved self-adaptive fitting capability, improves the clamping stability and tree body protection, and guides the fruit to roll efficiently to the fruit collection area. The umbrella-type electric telescopic rod is fixedly located below the lower comb-brush chassis via the connecting member, and the bottom end thereof is covered by a flexible buffer material, so as to enhance the adaptability to tree-drying, reduce the risk of damage and improve the efficiency of the collection; the included angle (acute angle) between the umbrella-type electric telescopic rod and the horizontal plane gradually increases as the rib-type electric telescopic rod moves away from the conveying mechanism, ensuring that the fruit is efficiently rolled to the conveying mechanism by gravity.

The screw and the stepping motor in the screw slider lifting mechanism of the present invention are connected to the stepping motor via a quincunx coupling to realize the height adjustment of the imaging sensor; the spindle is connected to the trolley plate via a bearing, and the transmission motor drives the spindle to rotate via the belt, so as to switch the core function of the fruit phenotype detection mode and the dry fruit harvesting mode; the imaging sensor has high resolution and wide dynamic range characteristics, maintains high sensitivity and stable imaging under low illumination conditions, ensures real-time precise acquisition of the trunk and fruit image information in a dynamic environment, and realizes automatic fruit detection and precise recovery of the fruit in combination with an image processing algorithm in the control module of the control box.

The roller on the trolley plate of the present invention is made of a wear-resistant high-strength alloy material, the rim is provided with a V-shaped guide groove, and the guide rail flange with the semi-circular arc forms a 0.5-1 mm precision clearance fit; the walking motor of the walking driving mechanism uses a planetary reduction motor, the planetary reduction motor drives the trolley plate via the gear, and provides accurate sliding control for the dual-mode drive monitoring comb module, so that the dual-mode drive comb module can be adjusted according to requirements, so as to ensure the adaptability to different types of fruit.

According to the present invention, the electric conveying mechanism is adopted, the surface of the conveyor belt in the electric conveying mechanism is manufactured by using a food-grade polyurethane material, and a hemispherical polyurethane protrusion with a height of 5 mm is designed, which is distributed in a diamond array, which effectively ensures the lossless, anti-skid and smooth transmission of the fruit; the front and rear support columns are made of a lightweight aluminum alloy, and are fixed on the frame via bolts, so as to ensure that the conveying process is stable and durable.

The invention platform working height range of 1-3 meters, can be adapted to tree dry fruit species (such as walnut, chestnut, pecan and hawaii, etc.). For morphological features of different dried fruit, the platform can adjust the comb parameters to adapt to the recovery requirements. The platform is capable of intelligently recognizing the ripeness of dry fruit and driving the spindle through the transmission motor 213 and the travel motor 209 in the dual-mode driven monitoring brush module to realize the precise rotation of the brush bar and ensure its efficient fruit collection at the designated position in the tree canopy.

Compared with the prior art, the technical solution provided by the present invention has the following beneficial effects:
(1) The present invention adopts the precise adjustment system driven by the imaging sensor and the transmission motor 213 and the walking motor 209 to switch the core function of the fruit phenotype detection mode and the dry fruit harvesting mode. The phenotype characteristic of the fruit is monitored in real time by the imaging sensor, and the ripeness of the fruit is determined in combination with the existing intelligent algorithm, and the recovery procedure is started only when the fruit reaches the picking criteria, thereby avoiding false production of immature fruit. At the same time, the free movement of the slider of the screw slider lifting mechanism can dynamically adjust the height of the sensor according to the position of the fruit, thereby further improving the recovery efficiency.
(2) The present invention adopts an umbrella-type electric telescopic rod design, which can accurately adjust the length according to the chest diameter of the tree, and at the same time, the polyurethane buffer kit at the bottom of the umbrella-type electric telescopic rod ensures a tight fit with the trunk, effectively preventing tree branch damage and fruit dropping. The design of the gap between the rib-type electric telescopic rods enables the fruit and leaves that do not meet the picking criteria to fall naturally, thereby ensuring the purity and mass of fruit harvesting. The high-efficiency combination of the umbrella-type electric telescopic rod and the conveying mechanism achieves precise collection and rapid delivery of the fruit, thereby greatly improving the harvesting efficiency.
(3) The surface of the brush rod of the present invention is provided with a plurality of protrusions, which can increase the impact area and strength of the fruit Via the protrusion design, the comb brush rod can form a staggered contact interface in the spatial dimension, thereby effectively improving the recovery efficiency. The design can adapt to the diversity characteristics of the phenotype of different fruit tree fruit, can still maintain a higher fruit harvesting rate in a complex canopy environment, and improve the reliability and stability of the picking operation.
(4) According to the present invention, a “phenotype monitoring-comb harvesting” dual-mode collaborative architecture is adopted, and automatic detection of fruit ripeness is achieved via left and right detection picking mechanisms, the efficiency is high, and the accuracy is high; the non-destructive and precise separation of fruit is achieved via a flexible comb brush technology and a dynamic mode switching mechanism. The left and right screening leaf collecting fruit mechanisms adaptively adjust the height and inclination angle of a collection via an umbrella-type electric telescopic rod, thereby effectively avoiding the hybrid of fruit and leaves, and further improving the recovery efficiency. The overall structure and the labor intensity of the operation process are low, the device structure is also simple, the manufacturing cost is low, the maintenance difficulty is small, and the present invention is suitable for dwarf dense orchard and economic forest scenes.

### BRIEF DESCRIPTION OF THE DRAWINGS

FIG. 1 is a schematic diagram of the overall structure of the left detection picking mechanism and the right detection picking mechanism of the present invention after being opened.

FIG. 2, FIG. 3, FIG. 4 and FIG. 5 all show schematic diagrams of the overall structure of the present invention after the left detection picking mechanism and the right detection picking mechanism are closed.

FIG. 6 is a schematic structural diagram of a left screening leaf collecting fruit mechanism and a right screening leaf collecting fruit mechanism according to the present disclosure.

FIG. 7 and FIG. 8 both show schematic diagrams of the structure of the present invention after hiding the left detection picking mechanism and the right detection picking mechanism.

FIG. 9 shows a schematic diagram of the structure of the present invention after hiding the fruit collection box.

FIG. 10 is a schematic structural diagram of a left detection picking mechanism or a right detection picking mechanism according to the present disclosure.

FIG. 11 is a partial enlarged view of A in FIG. 10.

FIG. 12 is a partial enlarged view of B in FIG. 10.

FIG. 13 is a schematic structural diagram of a right detection picking mechanism.

FIG. 14 is a partial enlarged view of C in FIG. 13.

FIG. 15 is a state diagram of the left screening leaf collecting fruit mechanism and the right screening leaf collecting fruit mechanism holding the fruit tree.

FIG. 16 is a structural schematic diagram of the conveying mechanism according to the present invention.

FIG. 17 is a schematic diagram of the fruit phenotype detection mode according to the present invention.

FIG. 18 is a schematic diagram of a dry fruit harvesting mode according to the present invention.

FIG. 19 is an angle change diagram of the umbrella-type electric telescopic rod according to the present invention.

### DETAILED DESCRIPTION OF THE INVENTION

In order to make the objectives and embodiments of the present disclosure clearer, the technical solutions of the present disclosure will be described in detail below with reference to the accompanying drawings. The present invention is applicable to various natural elements, and is particularly suitable for various natural elements (such as walnut, chestnut, pecan and Hawaii fruit, etc.), and can stably operate in a complex field environment.

The fixed connection described in the present platform may be fixed via welding, bolt fixing, etc. In combination with different use environments, different fixing means are used, and the rotational connection may be assembling the bearing on the shaft via a hot assembly or a cold assembly process.

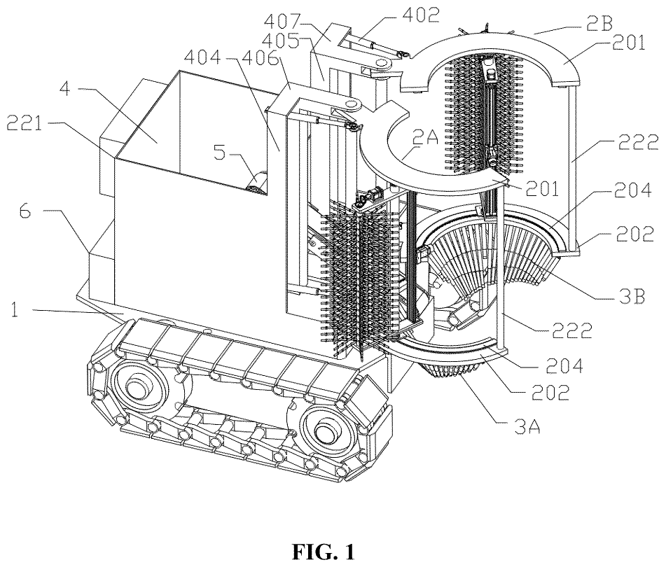

As shown in FIG. 1 to FIG. 5, an integrated platform of dual-mode switching dry fruit detection and screening leaves collecting fruit includes a frame body 1, a left detection picking mechanism 2A, a right detection picking mechanism 2B, a left screening leaf collecting fruit mechanism 3A, a right screening leaf collecting fruit mechanism 3B, a conveying mechanism 5 and a fruit collecting box 4, a fruit collecting box 4 is mounted on the frame body 1, a left side of the fruit collecting box 4 is connected to the left detecting picking mechanism 2A via a left rotation driving mechanism, and a right side of the fruit collecting box 4 is connected to the right detecting picking mechanism 2B via a right rotation driving mechanism; and the left rotation driving mechanism is configured to drive the left detection picking mechanism 2A to rotate, and the right rotation driving mechanism is configured to drive the right detection picking mechanism 2B to rotate. the left detection picking mechanism 2A and the right detection picking mechanism 2B can be closed or opened when rotating, and the fruit tree is located between the left detection picking mechanism 2A and the right detection picking mechanism 2B.

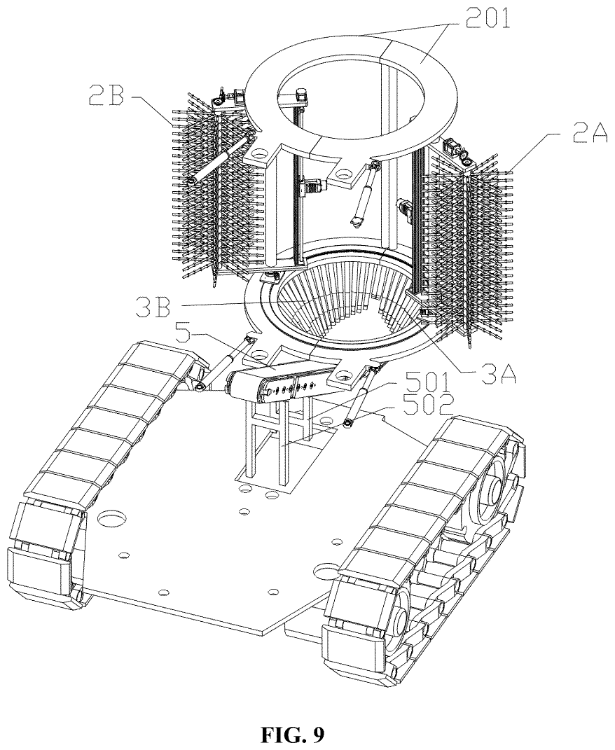

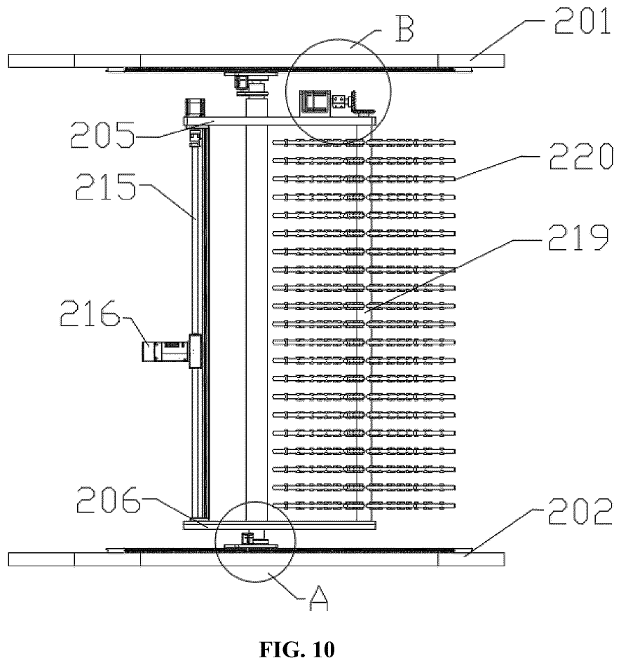

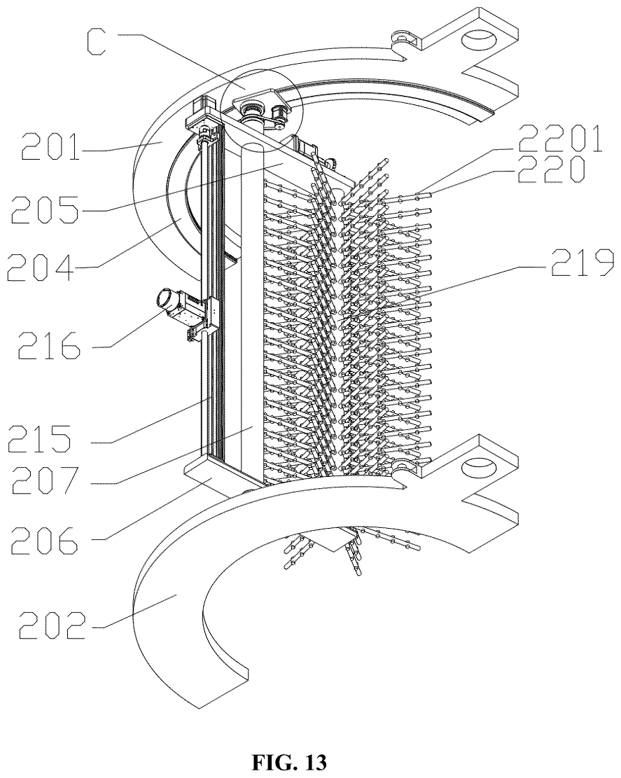

As shown in FIG. 9, FIG. 10 and FIG. 13, the left detection picking mechanism 2A and the right detection picking mechanism 2B have the same structure and are symmetrically arranged, and both include an upper comb brush chassis 201, a lower comb brush chassis 202, and a dual-mode drive monitoring comb module. The dual-mode drive monitoring comb module comprises a module mounting frame, a fruit monitoring module, and a comb brush module. The lower surface of the upper comb brush chassis 201 and the upper surface of the lower comb brush chassis 202 are each welded with a semi-circular annular guide rail 204. The module mounting frame comprising an upper mounting plate 205, a lower mounting plate 206 and a spindle 207, the upper mounting plate 205 being fixedly connected to the upper portion of the spindle 207, and the lower mounting plate 206 being fixedly connected to the lower portion of the spindle 207. The spindle 207 serves as a core transmission component, and both the top and the bottom of the spindle 207 are rotatably connected to the trolley plate 208 via bearings, thereby realizing rotary support. The trolley plate 208 is slidably connected to the guide rail 204, the trolley plate 208 located at the bottom of the spindle 207 is provided with a walking driving mechanism for driving the trolley plate 208 to move along the guide rail 204, and the trolley plate 208 located at the top of the spindle 207 is provided with a spindle rotation driving mechanism for driving the spindle 207 to rotate. The spindle rotation driving mechanism realizes the rapid switching of the operation platform between the fruit phenotype detection mode and the dry fruit harvesting mode. The fruit monitoring module is arranged between one end of the upper mounting plate 205 and one end of the lower mounting plate 206, and the comb brush module is arranged between the other end of the upper mounting plate 205 and the other end of the lower mounting plate 206; the fruit monitoring module is used for collecting images of fruit on the fruit tree 7 and detecting the ripeness of the fruit, and the comb brush module is used for picking fruit on the fruit tree 7.

The spindle 207 can be switched between the fruit phenotype detection mode and a dry fruit harvesting mode; in the fruit phenotype detection mode, the spindle 207 drives the fruit monitoring module to rotate to acquire the fruit phenotype image. In the fruit harvesting mode, the spindle 207 drives the comb brush module to rotate to realize comb-type harvesting of the fruit; the switching between the fruit detection mode and the fruit harvesting mode drives different modules to enter the working path via the rotation of the spindle 207, thereby achieving dynamic switching of the physical structure level.

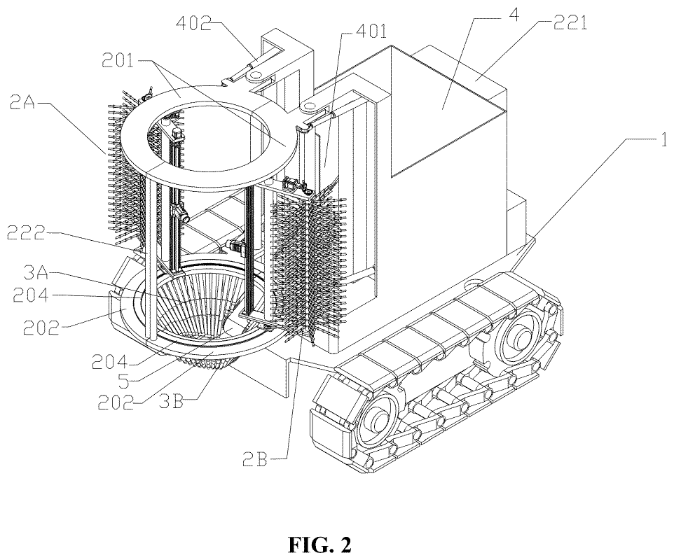

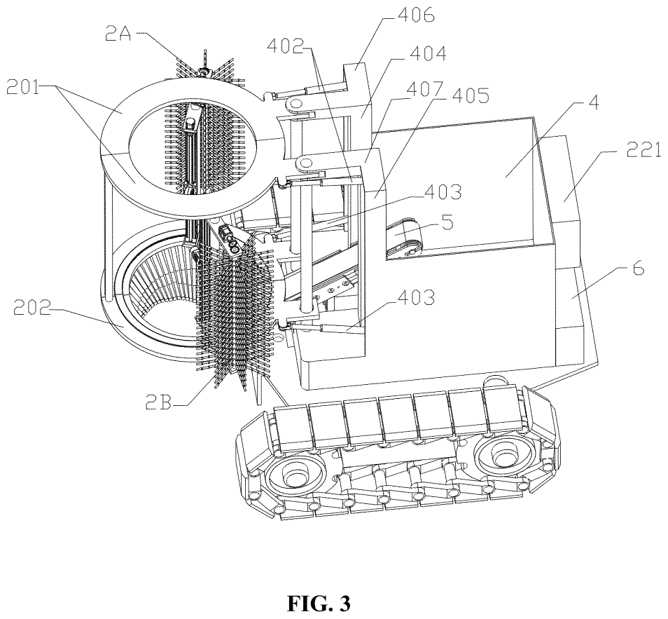

As shown in FIGS. 1-2, one end of the upper comb brush chassis 201 of the left detection picking mechanism 2A and one end of the lower comb brush chassis 202 of the left detection picking mechanism 2A are connected to each other via a strut 222, one end of the upper comb brush chassis 201 of the right detection picking mechanism 2B and one end of the lower comb brush chassis 202 of the right detection picking mechanism 2B are connected to each other via a strut 222.

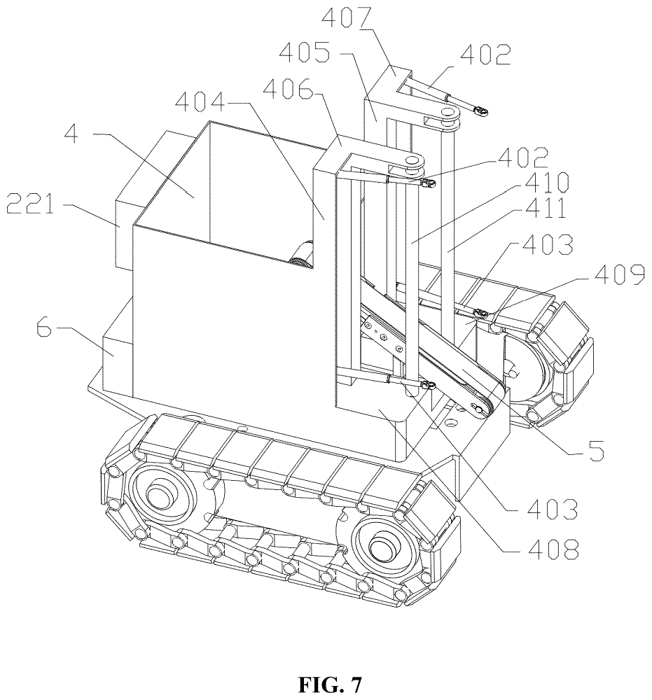

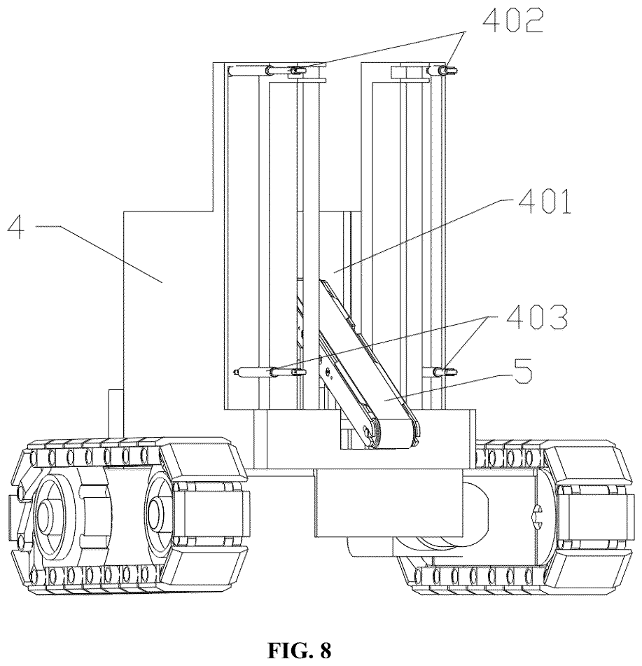

As shown in FIGS. 7-8, the middle part of the front side surface of the fruit collection box 4 is provided with a notch 401. The left detection picking mechanism 2A and a left screening leaf collecting fruit mechanism 3A located on the left side of the notch 401, and the right detection picking mechanism 2B and the right screening leaf collecting fruit mechanism 3B are located on the right side of the notch 401. The left rotation driving mechanism and the right rotation driving mechanism are respectively located on the left and right sides of the notch 401, the structures of the left rotation driving mechanism and the right rotation driving mechanism are the same, and each of the left rotation driving mechanism and the right rotation driving mechanism comprises an upper hydraulic telescopic rod 402 and a lower hydraulic telescopic rod 403.

The top of the front side surface of the fruit collection box 4 is provided with an upwardly extending left support frame 404 and an upwardly extending right support frame 405; the left support frame 404 is located above the left side of the notch 401, and the right support frame 405 is located above the right side of the notch 401; the top of the left support frame 404 is fixed with a left L-shaped connecting plate 406, and the top of the right support frame 405 is fixed with a right L-shaped connecting plate 407. The left L-shaped connection plate 406 is rotatably connected to one end of the connection lug on the upper comb brush chassis 201 in the left detection picking mechanism 2A, and at the same time, the left L-shaped connection plate 406 is rotatably connected to one end of the upper hydraulic telescopic rod 402, and the other end of the upper hydraulic telescopic rod 402 is rotatably connected to the other end of the connection lug on the upper comb brush chassis 201 in the left detection picking mechanism 2A; the right L-shaped connection plate 407 is rotatably connected to one end of the connection lug on the upper comb brush chassis 201 in the right detection picking mechanism 2B, and at the same time, the right L-shaped connection plate 407 is rotatably connected to one end of the upper hydraulic telescopic rod 402, and the other end of the upper hydraulic telescopic rod 402 is rotatably connected to the other end of the connection lug on the upper comb brush chassis 201 in the right detection picking mechanism 2B.

The bottom of the front side of the fruit collection tank 4 is provided with a forwardly extending left base 408 and a forwardly extending right base 409, the left base 408 is located below the left side of the notch 401, and the right base 409 is located below the right side of the notch 401, a left fixing shaft 410 is fixed to the left base 408 and a right fixing shaft 411 is fixed to the right base 409.

The left fixed shaft 410 is rotatably connected to one end of the connection lug on the lower comb brush chassis 202 in the left detection picking mechanism 2A via the left fixed shaft 410, and at the same time, the bottom of the left side of the front side of the fruit collection box 4 is rotatably connected to one end of the lower hydraulic telescopic rod 403, and the other end of the lower hydraulic telescopic rod 403 is rotatably connected to the other end of the connection lug on the lower comb brush chassis 202 in the left detection picking mechanism 2A; the right fixing shaft 411 is rotatably connected to one end of the connection lug on the lower comb brush chassis 202 in the right detection picking mechanism 2B, and at the same time, the bottom of the right side of the front side of the fruit collection box 4 is rotatably connected to one end of the lower hydraulic telescopic rod 403, and the other end of the lower hydraulic telescopic rod 403 is rotatably connected to the other end of the connection lug on the lower comb brush chassis 202 in the right detection picking mechanism 2B.

The upper comb brush chassis 201 and the lower comb brush chassis 202 are both semi-circular annular chassis, and the guide rail 204 is a semicircular annular guide rail; the two upper hydraulic telescopic rods 402 are used for respectively driving one end of the two upper comb brush chassis 201 to be separated or closed, and the two lower hydraulic telescopic rods 403 are used for respectively driving one end of the two lower comb brush chassis 202 to be separated or closed. The separate schematic diagram is shown in FIG. 1, and the closed schematic diagram is shown in FIG. 2.

Both the trolley plate 208 at the top of the spindle 207 and the trolley plate 208 at the bottom of the spindle 207 are rotatably connected with rollers 212 that are in rolling connection with the guide rail 204.

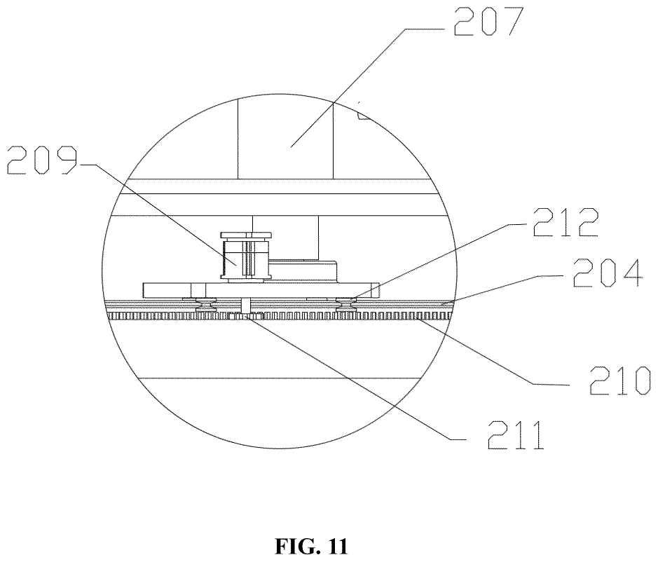

The trolley plate 208 at the bottom of the spindle 207 is provided with a walking driving mechanism, as shown in FIGS. 10 to 11, the walking driving mechanism comprises a walking motor 209, a semicircular ring rack 210 and a gear 211, one side of the guide rail 204 is fixed with the rack 210, the trolley plate 208 is provided with a walking motor 209, the output of the walking motor 209 is connected to the gear 211, and the gear 211 meshes with the rack 210. The walking motor 209 uses a planetary reduction motor, and the walking motor 209 drives the trolley plate 208 to move via the gear 211 and the rack 210, and at the same time, the trolley plate 208 implements smooth sliding along the semi-circular arc guide rail 204 via the roller 212, so that the orientation of the fruit monitoring module and the comb brush module can be adjusted in real time according to the position of the fruit tree, thereby effectively improving the recovery efficiency.

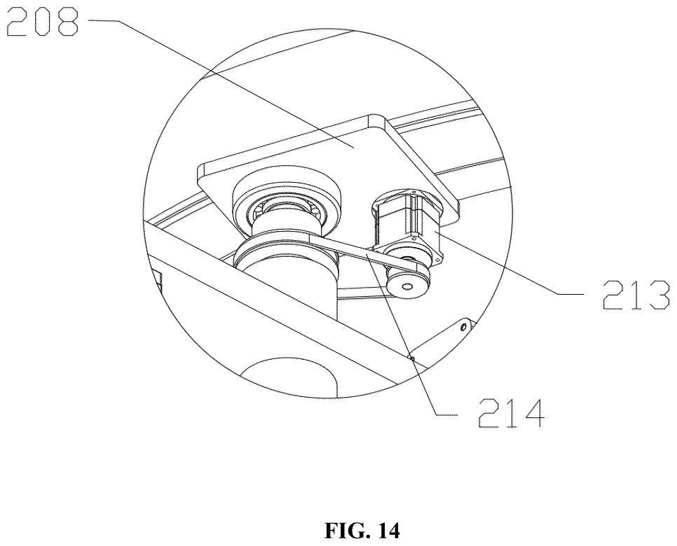

As shown in FIG. 13 to FIG. 14, the trolley plate 208 at the top of the spindle 207 is provided with a spindle rotation driving mechanism, the spindle rotation driving mechanism comprises a transmission motor 213, a belt 214, a main pulley and a auxiliary pulley, the trolley plate 208 is provided with a transmission motor 213, the output end of the transmission motor 213 connected to the main pulley, the outer circular surface of the spindle 207 is fixed with the auxiliary pulley, and the main pulley and the auxiliary pulley are in transmission connection via the belt 214. When the transmission motor 213 is in operation, the spindle 207 is driven to rotate via the belt 214. The rotation of the spindle 207 can switch the fruit monitoring module or the comb brush module to work towards the fruit.

As shown in FIGS. 1-5, 10, and 13, the fruit monitoring module includes a screw slider lifting mechanism 215, an imaging sensor 216 and a control box 221, and the control box 221 is mounted on a rear side surface of the fruit collection tank 4. the imaging sensor 216 is connected to the slider in the screw slider lifting mechanism 215 via a quick-release connecting plate, the top of the screw slider lifting mechanism 215 is connected to one end of the upper mounting plate 205, and the bottom of the screw slider lifting mechanism 215 is connected to one end of the lower mounting plate 206. Both the screw slider lifting mechanism 215 and the imaging sensor 216 are electrically connected to the control box 221.

The screw slider lifting mechanism 215 comprises a stepping motor, a screw, a slider, a sliding rail, etc. The imaging sensor 216 is mounted on the slider via the quick-release connecting plate. The screw and the stepping motor are tightly linked via the quincunx coupling, the slider is in threaded connection with the screw, the slider is slidably connected to the sliding rail, and the sliding rail is arranged in parallel with the screw. Under the drive of the stepper motor, the screw rotates, and the slider can freely move up and down along the screw and the slide rail, thereby achieving precise adjustment of the height of the imaging sensor 216.

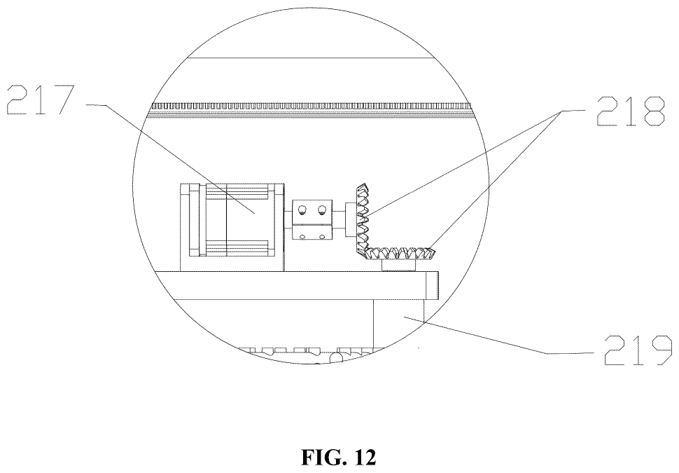

As shown in FIGS. 10 and 12, the comb brush module comprises a comb brush motor 217, a bevel gear system 218 and a comb brush shaft 219; the bottom of the comb brush shaft 219 is rotatably connected to the other end of the lower mounting plate 206 via a bearing; the top of the comb brush shaft 219 is rotatably connected to the other end of the upper mounting plate 205 via a bearing, the upper end of the comb brush shaft 219 penetrates the upper mounting plate 205 and then is in transmission connection with the output shaft of the comb brush motor 217 via the bevel gear system 218; the comb brush motor 217 is connected to the upper mounting plate 205 via the comb brush motor mounting plate; the comb brush motor 217 drives the comb brush shaft 219 to rotate via the bevel gear system 218, the comb brush shaft 219 is fixedly connected to a plurality of comb brush rods 220, the surface of the comb brush rod 220 is provided with a plurality of protrusions 2201. The bevel gear systems 218 composed of a pair of bevel gears, one bevel gear is fixed on the output shaft of the comb brush motor 217, and the other bevel gear is connected to the upper end of the comb brush shaft 219. Preferably, the gear tooth-shaped design of the bevel gear adopts an involute tooth shape, so as to ensure smooth engagement between the gears and little noise and vibration during the transmission process, thereby avoiding fruit damage caused by uneven power transmission. The gear material uses a high-strength alloy steel, and the hardness and wear resistance thereof are enhanced via a heat treatment process, thereby prolonging the service life. Under the drive of the comb-brush motor 217, the bevel gear transfers the rotational force from the output shaft of the comb-brush motor 217 to the comb-brush shaft 219, so as to drive the comb-brush rod 220 to rotate, and at the same time, the rotation speed of the comb-brush shaft 219 and the comb-brush rod 220 can be adjusted between 1000 and 1500 r/min, ensuring that it completes fruit harvesting at an appropriate rotational speed.

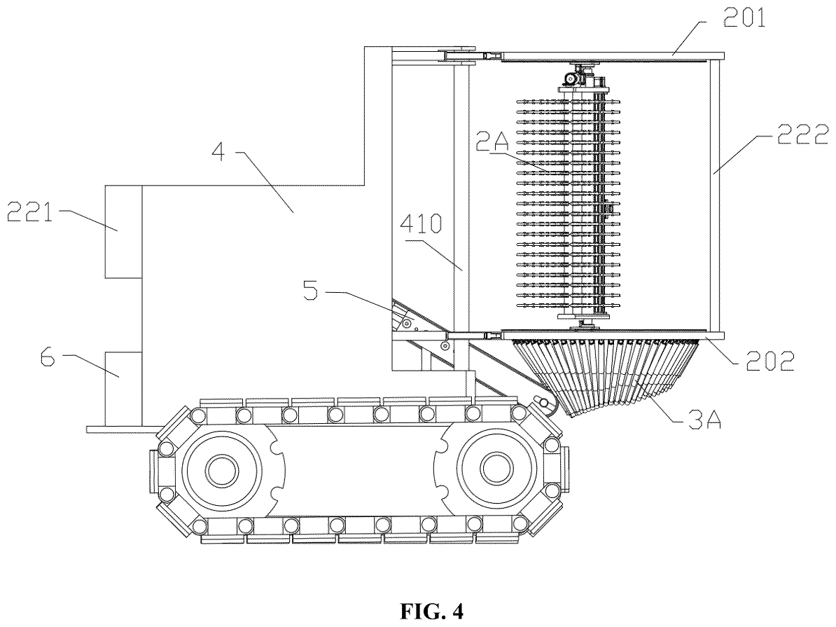

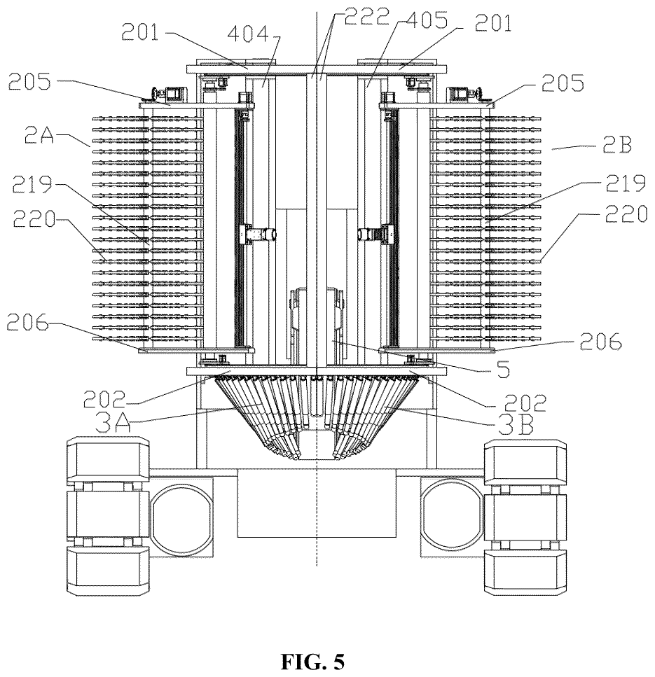

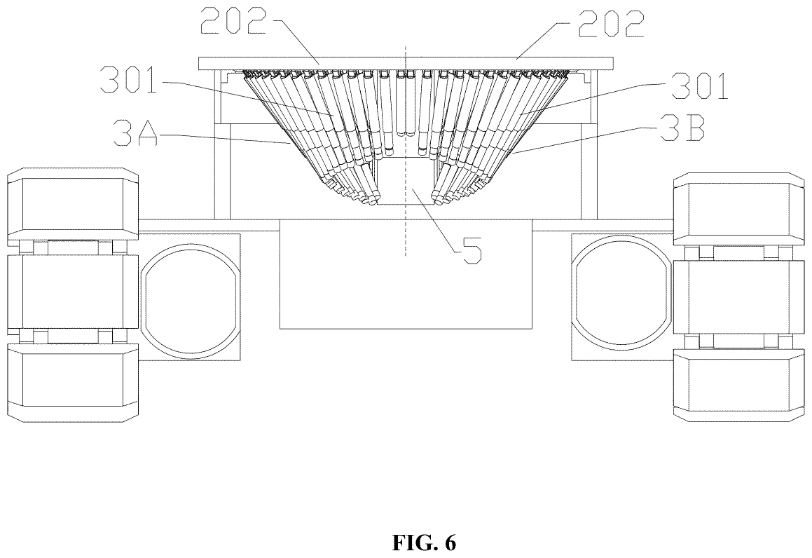

As shown in FIG. 5 and FIG. 6, the lower comb brush chassis 202 of the left detection picking mechanism 2A is provided with a left screening leaf collecting fruit mechanism 3A, and the lower comb brush chassis 202 of the right detection picking mechanism 2B is provided with a right screening leaf collecting fruit mechanism 3B The left screening leaf collecting fruit mechanism 3A and the right screening leaf collecting fruit mechanism 3B have the same structure and are symmetrically arranged, and both include a plurality of umbrella-type electric telescopic rods 301.

As shown in FIG. 1 to FIG. 4, one end of the conveying mechanism 5 is located between the left screening leaf collecting fruit mechanism 3A and the right screening leaf collecting fruit mechanism 3B structure and located below the two lower comb brush chassis 202, and the other end of the conveying mechanism 5 extends from the notch 401 to the upper side of the fruit collecting box 4.

The bottom ends of the umbrella-type electric telescopic rods 301 in the left screening leaf collecting fruit mechanism 3A and the right screening leaf collecting fruit mechanism 3B are both used for attaching trunk surfaces and collecting and rolling the falling fruit to the conveying mechanism 5, and the conveying mechanism 5 is used for conveying the fruit into the fruit collecting box 4. The umbrella-type electric telescopic rod 301 forms a rigid connection with the lower comb-brush chassis 202 via a connecting member. The umbrella-type electric telescopic rod 301 comprises a main drive rod body and at least two independently adjustable sleeve rods, each sleeve rod realizing axial displacement via a high-precision threaded transmission pair. Preferably, the control system of the umbrella-type electric telescopic rod 301 is integrated in the control box 221, a closed-loop servo control mode is used, and the digital displacement sensor is equipped with a real-time feedback rod extension of the rod, and the positioning precision thereof can reach ±0.5 mm. The bottom of the umbrella-type electric telescopic rod 301 is provided with a polyurethane buffer kit. The shape of the plurality of umbrella-type electric telescopic rods is similar to that of a umbrella ribs.

During the harvesting operation, the umbrella-type electric telescopic rod 301 extends from the lower comb-brush chassis 202 to the central direction, and the polyurethane buffer kit at the bottom of the rib-type electric telescopic rod 301 is adaptively attached to the curved surface of the trunk surface via deformation compensation. The fruit gradually fall off during the comb brush and roll to the surface of the telescopic rod under the action of gravity. The closer the umbrella-type electric telescopic rod 301 is to the conveying mechanism 5, the smaller the included angle between the umbrella-type electric telescopic rod 301 and the horizontal plane is, the fruit rolls on the surface of the rods and eventually enters the conveying mechanism 5. The gap between neighbouring umbrella-type electric telescopic rods 301 is designed to allow fruit and leaves that do not meet the picking standard to fall off naturally, thereby reducing the mixing of branches and leaves and ensuring the purity of the collected fruit. Specifically, the gap between neighbouring umbrella-type electric telescopic rods 301 is designed to be 15-20 mm (less than the common dry fruit diameter of 25-40 mm), and preliminary fruit leaf separation can be realized, thereby ensuring the effect of the screening leaves while preventing the fruit from falling off. All adjustment components of the umbrella-type electric telescopic rod 301 adopt a wear-resistant material and a high-strength alloy steel, so as to ensure durability and stability in long-term and high-frequency work.

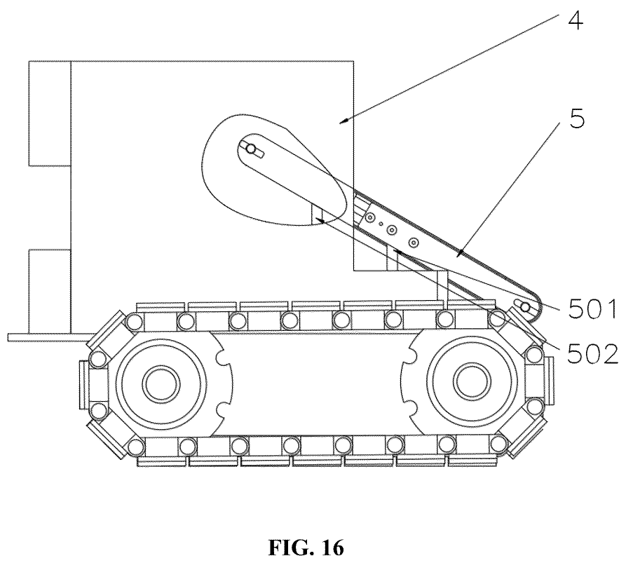

The conveying mechanism 5 adopts an existing electric conveying mechanism, as shown in FIG. 16, the conveying mechanism 5 is connected to the frame body 1 via the front supporting column 501 or is connected to the bottom of the outer side of the fruit collecting box 4, and the conveying mechanism 5 is further connected to the bottom of the inner side of the fruit collecting box 4 via the rear supporting column 502. During the comb brush operation, the harvested fruit falls by gravity onto the surface of the umbrella-type electric telescopic rods 301 and rolls due to gravity onto the conveyor belt in the conveying mechanism 5. The conveying mechanism integrates a built-in motor and has a compact structure; the conveyor belt made of food grade polyurethane, and a hemispherical polyurethane protrusion with a height of 5 mm is designed on the surface to be distributed in a diamond array, so as to ensure that the fruit can be lossless, smooth, and smoothly conveyed to the fruit collection box 4, which can effectively prevent dry fruit damage. The front support column 501 and the rear support column 502 are made of a lightweight aluminum alloy, the front support column 501 and the rear support column 502 are respectively fixed on the frame body 1 or the fruit collection tank 4 via bolts and are connected to the conveying mechanism 5 to ensure that the conveying process is stable and durable.

A counterweight block 6 is further mounted on the frame body 1.

The present embodiment further comprises a power supply, the umbrella-type electric telescopic rods 301, the walking motor 209 of the walking driving mechanism, the transmission motor 213 of the spindle rotation driving mechanism, the screw slider lifting mechanism 215 of the fruit monitoring module, the comb brush motor 217 of the comb brush module and the electric conveying mechanism of the conveying mechanism 5 are all electrically connected to the control box 221, and the control box 221 is further used for controlling the action of the upper hydraulic telescopic rod 402 and the lower hydraulic telescopic rod 403. The umbrella-type electric telescopic rod 301, the walking motor 209 of the walking driving mechanism, the transmission motor 213 of the spindle rotation driving mechanism, the screw slider lifting mechanism 215 of the fruit monitoring module, the imaging sensor 216 of the fruit monitoring module, the comb brush motor 217 of the comb brush module, the electric conveying mechanism of the conveying mechanism 5 and a control box 221 are all electrically connected to the power supply.

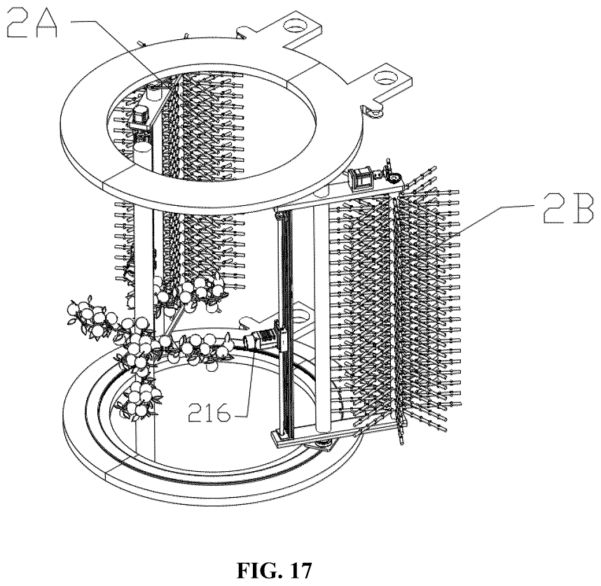

When the platform of the present embodiment is in an in-situ monitoring working state of the fruit phenotype, as shown in FIGS. 10 and 17, the stepping motor in the screw slider lifting mechanism 215 drives the imaging sensor 216 to move axially along the screw via the precision transmission mechanism, the stepping motor in the screw slider lifting mechanism 215 is connected to the control box 221 by means of signals, and the vertical working position of the imaging sensor 216 is accurately adjusted according to a preset program or a real-time feedback signal; the screw is provided with a travel interval adapted to the height of the tree crown of the fruit tree, and the travel interval can also be dynamically calibrated via the height data of the crown layer acquired by the tree height measurement module; the imaging sensor 216 moves vertically along the screw to realize the automatic adjustment of the working position of the imaging sensor 216, so as to adapt to the tree crown height and fruit distribution of the tree. The height adjustment mechanism can be flexibly adjusted according to the growth characteristics of different fruit trees (such as tree height, fruit distribution level, etc.), thereby ensuring the comprehensive and accurate imaging detection of fruit. The imaging sensor 216 has high-resolution and wide dynamic range characteristics, and can be combined with an image recognition algorithm in the control box 221 to determine the ripeness of the fruit (the process of ripeness detection using the prior art, which is not within the protection scope of the present invention) by acquiring multi-dimensional data such as the color, shape and texture of the fruit surface In addition, the control box 221 can also analyze the growth condition and the mature trend of the fruit by comparing the plurality of images to provide accurate data support for recovery.

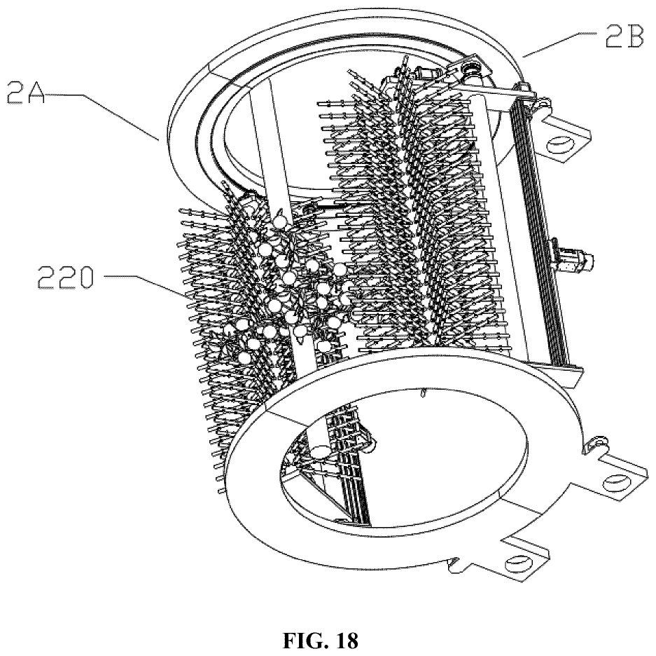

When the platform is in the dry fruit harvesting work state, the imaging sensor 216 acquires environmental information of the operation scene in real time, and cooperates with the comb brush module to form a dynamic response mechanism. When the imaging sensor 216 detects that the fruit reaches a preset recovery requirement, the control box controls the spindle rotation driving mechanism to operate, and the transmission motor 213 drives the spindle 207 to rotate via the belt 214, so that the comb brush rod 220 in the comb brush module moves to one side of the fruit tree, as shown in FIG. 18, the comb brush motor 217 is started, and the comb brush shaft 219 is driven to rotate via the bevel gear system 218, thereby completing the comb brush operation. During the comb brush, the 60° V-shaped guide groove of the roller 212 and the V-shaped outer edge of the semi-circular arc guide rail 204 form a 0.5-1 mm precision clearance fit.

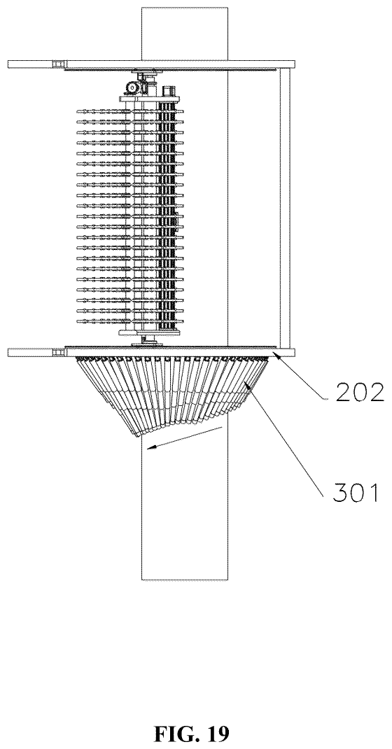

When the platform executes the harvesting operation, the two upper comb brush chassis 201 and the two lower comb brush chassis 202 firmly grip the target fruit tree via the upper hydraulic telescopic rod 402 and the lower hydraulic telescopic rod 403, and provide stable support for the harvesting operation. At the same time, the further away from the conveyor mechanism 5 the umbrella-type electric telescopic rod 301 below each lower brush chassis 202 is, the greater the angle (acute angle) of the umbrella-type electric telescopic rod 301 with the horizontal plane is, and each rib-type electric telescopic rod 301 forms a guide curved surface arranged in a spiral involute, so that the combined action of gravity and angle change is used, as shown by the arrow in FIG. 19, the fruit smoothly falls onto the conveying mechanism 5. The design effectively optimizes the collection path of the fruit, ensuring that the fruit can enter the conveying system quickly and completely, thereby improving the recovery efficiency and the accuracy of fruit collection.

The existing crawler chassis module is arranged at the bottom of the frame body 1, and the crawler chassis module can significantly improve the working performance of the working platform under complex terrain conditions. The core advantage of the module is to enhance the working adaptability and stability of the platform under complex terrain conditions, and has strong traction force, so that the platform can effectively cope with a variety of typical orchard terrain including hilly hill ground, wet slide area, and muddy environment, thereby ensuring that the entire work platform is traveling and stable, and providing reliable guarantee for subsequent fruit precise recovery tasks.

On the basis of the above platform, the present embodiment further provides an integrated platform operation method for dual-mode switching dry fruit detection and screening, comprising the following steps:
Step 1, the frame body 1 moves to the vicinity of the target fruit tree 7 via the crawler chassis module arranged at the bottom thereof, ensuring accurate positioning and stable operation. The whole apparatus of the present embodiment can be picked via remote control, that is, the remote control apparatus is wirelessly connected to the control box 221, and the control box 221 can control the track-type chassis module to walk and steer via the instruction of the remote control apparatus. The user can also send a signal to the control box 221 via the remote control device, and the control box 221 controls the actions of different mechanisms. The initial state, the left detection picking mechanism 2A and the right detection picking mechanism 2B are the state shown in FIG. 1.

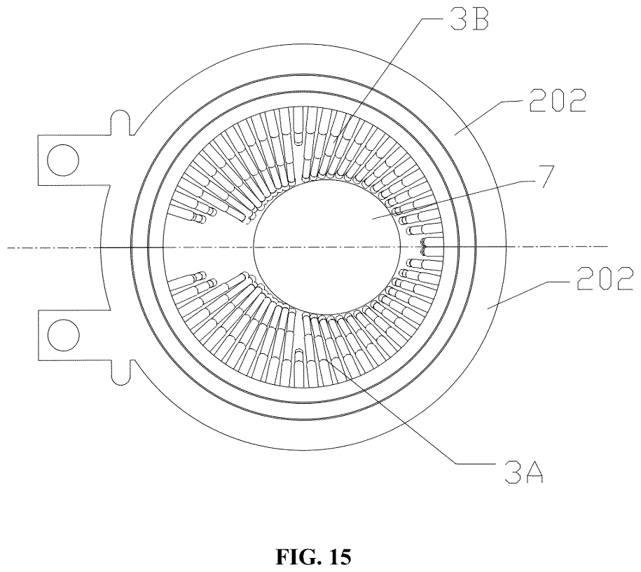

When the frame body 1 moves to the vicinity of the target fruit tree 7, the two upper hydraulic telescopic rods 402 and the two lower hydraulic telescopic rods 403 act together to drive the left detection picking mechanism 2A and the right detection picking mechanism 2B to close, as shown in FIG. 2, that is, the two upper comb brush chassis 201 are closed and the two lower comb brush chassis 202 are closed, and the fruit tree 7 is located between the two upper comb brush chassis 201 and the two lower comb brush chassis 202; at the same time, the umbrella-type electric telescopic rod 301 in the left screening leaf collecting fruit mechanism 3A and the right screening leaf collecting fruit mechanism 3B is started, so that the bottom end of the umbrella-type electric telescopic rod 301 is attached to the surface of the trunk after the umbrella-type electric telescopic rod 301 is elongated, as shown in FIGS. 15 and 19;
Step 2, the left detection picking mechanism 2A and the right detection picking mechanism 2B respectively perform the following steps:
step 2.1, the spindle rotation driving mechanism is started, the spindle rotation driving mechanism drives the spindle 207 to rotate, so that the imaging sensor 216 in the fruit monitoring module faces the fruit to be detected on the fruit tree 7, as shown in FIG. 17.
Step 2.2, starting a screw slider lifting mechanism 215, wherein the screw slider lifting mechanism 215 drives the imaging sensor 216 to move up and down.
Step 2.3, the imaging sensor 216 acquires the fruit surface image of the fruit tree 7 during the up and down movement, and sends the image information to the control box 221 in real time; the control box 221 performs analysis processing according to the received image information to obtain the ripeness of the plurality of fruit in the image acquired by the imaging sensor 216 during the up and down movement; the ripeness of the plurality of fruit is averaged, and compared with the threshold, it is determined whether the fruit in the image acquired by the imaging sensor 216 during the up and down movement needs to be picked (the image processing analysis and determination process are in the prior art); if necessary, step 2.4 is performed; otherwise, step 2.6 is executed.
Step 2.4, the control box 221 controls the spindle rotation driving mechanism to act, the transmission motor 213 of the spindle rotation driving mechanism drives the spindle 207 to rotate via the belt 214 so that the comb brush module faces the fruit that needs to be picked in the fruit tree 7, as shown in FIG. 18. In the process of designing the overall size of the comb brush module, it is as much as possible to ensure that the comb brush rod 220, whilst rotating with the comb brush shaft 219 during fruit harvesting, maintains a harvesting range that broadly corresponds to the field of view captured by the imaging sensor 216.
Step 2.5, the comb brush module is started, and the comb brush motor 217 in the comb brush module drives the comb brush shaft 219 and the comb brush rod 220 to rotate via the bevel gear system 218, thereby achieving fruit picking; the picked fruit is rolled onto the conveying mechanism 5 from the umbrella-type electric telescopic rod 301, the conveying mechanism 5 conveys the fruit to the fruit collection box 4, and a baffle can also be provided on either side of the conveying mechanism 5 to prevent the fruit from rolling from the side surface of the conveying mechanism 5. The walking driving mechanism drives the spindle 207, the fruit monitoring module and the comb brush module back and forth along the guide rail 204 by means of the trolley plate 208. After the number of round-trip movements of the trolley plate 208 and the like reaches a preset number of times, the picking process is ended, otherwise step 2.6 is executed.
Step 2.6, starting the walking driving mechanism, the walking driving mechanism driving the spindle 207, the fruit monitoring module and the comb brush module moving a preset distance along the guide rail 204 via the trolley plate 208, and after the movement ends, if the imaging sensor 216 has facing the fruit to be detected on the fruit tree 7, returning to execute step 2.2; and if the imaging sensor 216 does not face the fruit to be detected on the fruit tree 7, returning to execute step 2.1. The cooperative action of the walking driving mechanism and the spindle rotation driving mechanism enables two imaging sensors 216 to efficiently collect fruit phenotype information of each 180° region on both sides of the crown, and provide reliable data support for accurate detection of fruit ripeness. After the control box determines that the fruit of a certain position reaches the picking condition (the picking condition can be set by the actual situation, for example, after the average ripeness of the fruit collected by the imaging sensor 216 in the process of moving up and down reaches a stored threshold, it indicates that the piece of fruit needs to be picked, that is, the picking condition is reached, which belongs to the fruit that needs to be picked), and the spindle rotation driving mechanism automatically adjusts the spindle 207 so that the comb brush rod 220 faces the side where the fruit to be picked (the fruit that needs to be picked) is located, and enters the picking stage.

In step 2.5, the picked fruit is rolled onto the conveying mechanism 5 from the umbrella-type electric telescopic rod 301, specifically:

The dropped fruit is collected by the umbrella-type electric telescopic rod 301 and rolled onto the conveyor belt of the conveying mechanism 5, and then conveyed by the conveyor belt to the fruit collection box. A spacing is provided between adjacent umbrella-type electric telescopic rods 301, and can realize the preliminary separation of fruit leaves when the platform collects a forest. At the same time, the spacing design of the adjacent umbrella-type electric telescopic rods 301 is less than the diameter of the fruit, so as to ensure the effect of the screening leaves while effectively preventing the fruit from falling out of the material.

In order to ensure complete recovery of the fruit, the platform of the present embodiment further designs a secondary scanning and supplementary picking function. After the initial picking is completed, the imaging sensor 216 again scans the crown area and identifies the fruit location that is not picked. Subsequently, the transmission motor 213 in the spindle rotation driving mechanism adjusts the rotation direction of the spindle 207, the trolley plate 208 slides to the target position under the drive of the walking motor 209, and the comb brush motor 217 starts to drive the comb brush rod 220 again to carry out the supplemental picking operation. The secondary picking process effectively improves the integrity of fruit harvesting, and avoids low efficiency and fruit loss caused by leakage.

According to the present invention, the dual-mode collaborative architecture realizes the dual-function integration of the fruit phenotype in-situ detection mode and the fruit harvesting mode and the seamless switching between modes. The dual-mode drive-type monitoring comb brush module uses an imaging sensing system and a precision screw slider adjustment mechanism driven by a stepper motor to realize the height self-adaptive adjustment of the imaging sensor, together with the spindle-controlled precise adjustment system for the position of the comb-brush rod, to construct a spatial sensing-harvesting synergistic operation mechanism, so as to ensure precise positioning of the fruit and non-destructive harvesting in a dynamic environment. The design of the umbrella-type electric telescopic rod integrates the functions of leaf sifting and fruit collection, and the telescopic length thereof can be accurately adjusted according to the chest diameter of the tree, thereby ensuring the adaptation to different trunk sizes. The polyurethane buffer kit provided at the bottom not only enhances the fit with the drying of the tree, effectively reduces the risk of tree branch damage, but also reduces the falling of fruit and improves the collection efficiency.

According to the umbrella-type electric telescopic rod, the extension length can be automatically adjusted according to actual requirements, thereby further improving the environmental adaptability and recovery accuracy of the recovery operation. A pressure sensor is provided between the polyurethane buffer kit and the bottom end of the umbrella-type electric telescopic rod 301; when the pressure sensor detects the pressure change, the pressure sensor sends a signal to the control box 221; the control box 221 determines, according to the magnitude of the pressure value of the pressure sensor, whether the umbrella-type electric telescopic rod 301 is attached to the trunk; and if it is determined that the umbrella-type electric telescopic rod 301 is attached, the umbrella-type electric telescopic rod is controlled to no longer be elongated.

Through the above innovative design, the present invention not only ensures the quality of fruit harvesting, improves the working efficiency, but also reduces fruit damage, optimizes the collection and conveying process of fruit, and has high application value and popularization prospect.

The protection scope of the present invention includes, but is not limited to, the above embodiments, and the protection scope of the present invention is subject to the claims, and any substitution, deformation, and improvement which would be easily conceived of by a person skilled in the art to which the present technology is made fall within the protection scope of the present invention.

What is claimed is:

1. A dual-mode switching platform integrating dry fruit detection and leaf screening fruit collection, comprising a frame body (1), a left detection picking mechanism (2A), a right detection picking mechanism (2B), a left screening leaf collecting fruit mechanism (3A), a right screening leaf collecting fruit mechanism (3B), a conveying mechanism (5), and a fruit collecting box (4); the fruit collection box (4) is mounted on the frame body (1), a left side of the fruit collection box (4) is connected to the left detection picking mechanism (2A) via a left rotation driving mechanism, and a right side of the fruit collection box (4) is connected to a right detection picking mechanism (2B) via a right rotation driving mechanism; the rotation driving mechanism is used for driving the left detection picking mechanism (2A) to rotate, and the right rotation driving mechanism is used for driving the right detection picking mechanism (2B) to rotate;
the left detection picking mechanism (2A) and the right detection picking mechanism (2B) have the same structure and are symmetrically arranged, each comprising an upper comb brush chassis (201), a lower comb brush chassis (202), and a dual-mode drive monitoring comb module; the dual-mode drive monitoring comb module comprises a module mounting frame, a fruit monitoring module and a comb brush module; the lower surface of the upper comb brush chassis (201) and the upper surface of the lower comb brush chassis (202) are each provided with a guide rail (204); the module mounting frame comprises an upper mounting plate (205), a lower mounting plate (206), and a spindle (207); the upper mounting plate (205) is connected to the upper portion of the spindle (207); the lower mounting plate (206) is connected to the lower portion of the spindle (207); both the top and the bottom of the spindle (207) are rotatably connected to a trolley plate (208); the trolley plate (208) is slidably connected to the guide rail (204); the trolley plate (208) is provided with a walking driving mechanism for driving the trolley plate (208) to move along the guide rail (204), and a spindle rotation driving mechanism for driving the spindle (207) to rotate; the fruit monitoring module is arranged between one end of the upper mounting plate (205) and one end of the lower mounting plate (206), and the comb brush module is arranged between the other end of the upper mounting plate (205) and the other end of the lower mounting plate (206); the fruit monitoring module is used for collecting images of fruit on the fruit tree (7) and detecting the ripeness of the fruit, and the comb brush module is used for picking fruit on the fruit tree (7);
the lower comb brush chassis (202) of the left detection picking mechanism (2A) is provided with a left screening leaf collecting fruit mechanism (3A), and the lower comb brush chassis (202) of the right detection picking mechanism (2B) is provided with a right screening leaf collecting fruit mechanism (3B); the left screening leaf collecting fruit mechanism (3A) and the right screening leaf collecting fruit mechanism (3B) have the same structure and are symmetrically arranged, each comprising a plurality of umbrella-type electric telescopic rods (301), the umbrella-type electric telescopic rods (301) being obliquely and fixedly connected to the bottom of the lower comb-brush chassis (202); one end of the conveying mechanism (5) is located between the left screening leaf collecting fruit mechanism (3A) and the right screening leaf collecting fruit mechanism (3B) structure and is located below the two lower comb brush chassis (202), and the other end extends upwards to above the inner side of the fruit collecting box (4); the bottom ends of the umbrella-type electric telescopic rods (301) in the left screening leaf collecting fruit mechanism (3A) and the right screening leaf collecting fruit mechanism (3B) are both used for attaching trunk surfaces and collecting and rolling the falling fruit to the conveying mechanism (5), and the conveying mechanism (5) is used for conveying the fruit to the fruit collection box (4) in the interior of the fruit collection box (4).

2. The dual-mode switching platform integrating dry fruit detection and leaf screening fruit collection, as recited in claim 1, wherein: a notch (401) is formed in the middle of the front side surface of the fruit collection box (4), and the other end of the conveying mechanism (5) extends from the notch (401) to the inner side of the fruit collection box (4); the left detection picking mechanism (2A) and the left screening leaf collecting fruit mechanism (3A) are located on the left side of the notch (401), and the right detection picking mechanism (2B) and the right screening leaf collecting fruit mechanism (3B) are located on the right side of the notch (401).

3. The dual-mode switching platform integrating dry fruit detection and leaf screening fruit collection, as recited in claim 2, wherein: the left rotation driving mechanism and the right rotation driving mechanism are respectively located on left and right sides of the notch (401), and structures of the left rotation driving mechanism and the right rotation driving mechanism are the same, and both include an upper hydraulic telescopic rod (402) and a lower hydraulic telescopic rod (403);
a left support frame (404) extending upwards and a right support frame (405) extending upwards are provided on the top of the front side surface of the fruit collection box (4);
the left support frame (404) is located above the left side of the notch (401), and the right support frame (405) is located above the right side of the notch (401);
the top of the left support frame (404) is rotatably connected to one end of the connection lug on the upper comb brush chassis (201) in the left detection picking mechanism (2A) via the left L-shaped connection plate (406), and at the same time, the top of the left support frame (404) is rotatably connected to one end of the upper hydraulic telescopic rod (402), and the other end of the upper hydraulic telescopic rod (402) is rotatably connected to the other end of the connection lug on the upper comb brush chassis (201) in the left detection picking mechanism (2A);
the top of the right support frame (405) is rotatably connected to one end of the connection lug on the upper comb brush chassis (201) in the right detection picking mechanism (2B) via the right L-shaped connection plate (407), and at the same time, the top of the right support frame (405) is rotatably connected to one end of the upper hydraulic telescopic rod (402), and the other end of the upper hydraulic telescopic rod (402) is rotatably connected to the other end of the connection lug on the upper comb brush chassis (201) in the right detection picking mechanism (2B);
the bottom of the front side of the fruit collection box (4) is provided with a left base

(408) and a right base (409) extending forward, the left base (408) is located below the left side of the notch (401), and the right base (409) is located below the right side of the notch (401);
the left base (408) is rotatably connected to one end of the connection lug on the lower comb brush chassis (202) in the left detection picking mechanism (2A) via the left fixed shaft (410), and at the same time, the bottom of the left side of the front side of the fruit collection box (4) is rotatably connected to one end of the lower hydraulic telescopic rod (403), and the other end of the lower hydraulic telescopic rod (403) is rotatably connected to the other end of the connection lug on the lower comb brush chassis (202) in the left detection picking mechanism (2A);
the right base (409) is rotatably connected to one end of the connection lug on the lower comb brush chassis (202) in the right detection picking mechanism (2B) via the right fixed shaft (411), and at the same time, the bottom of the right side of the front side face of the fruit collection box (4) is rotatably connected to one end of the lower hydraulic telescopic rod

(403) and the other end of the lower hydraulic telescopic rod (403) is rotatably connected to the other end of the connection lug on the lower comb brush chassis (202) in the right detection picking mechanism (2B).

4. The dual-mode switching platform integrating dry fruit detection and leaf screening fruit collection, as recited in claim 1, wherein: both the upper comb brush chassis (201) and the lower comb brush chassis (202) are semicircular annular chassis, and the guide rail (204) are semicircular annular guide rail; the two upper hydraulic telescopic rods (402) are used for respectively driving one end of the two upper comb brush chassis (201) to be separated or closed, and the two lower hydraulic telescopic rods (403) are used for respectively driving one end of the two lower comb brush chassis (202) to be separated or closed.

5. The dual-mode switching platform integrating dry fruit detection and leaf screening fruit collection, as recited in claim 1, wherein: the trolley plate (208) at the top of the spindle (207) and the trolley plate (208) at the bottom of the spindle (207) are rotatably connected with rollers (212) in rolling connection with the guide rail (204);
the trolley board (208) at the bottom of the spindle (207) is provided with a walking driving mechanism, the walking driving mechanism comprises a walking motor (209), a rack (210) and a gear (211), the rack (210) is connected to one side of the guide rail (204), the walking motor (209) is provided on the trolley board (208), the output of the walking motor (209) is connected to the gear (211), and the gear (211) meshes with the rack (210);
the trolley plate (208) at the top of the spindle (207) is provided with a spindle rotation driving mechanism, the spindle rotation driving mechanism comprises a transmission motor (213), a belt (214), a main pulley and a auxiliary pulley, the trolley plate (208) is provided with the transmission motor (213); the output end of the transmission motor (213) is connected to the main pulley, the outer circular surface of the spindle (207) is connected to the auxiliary pulley, the main pulley are in transmission connection with the auxiliary pulley via the belt (214).

6. The dual-mode switching platform integrating dry fruit detection and leaf screening fruit collection, as recited in claim 3, wherein: the fruit monitoring module comprises a screw slider lifting mechanism (215), an imaging sensor (216) and a control box (221), the control box (221) is connected to the rear side surface of the fruit collection box (4), the imaging sensor (216) is connected to the slider in the screw slider lifting mechanism (215), the top of the screw slider lifting mechanism (215) is connected to one end of the upper mounting plate

(205) the bottom of the screw slider lifting mechanism (215) is connected to one end of the lower mounting plate (206), both the screw slide lifting mechanism (215) and the imaging sensor (216) are electrically connected to the control box (221).

7. The dual-mode switching platform integrating dry fruit detection and leaf screening fruit collection, as recited in claim 6, wherein: the comb brush module comprises a comb brush motor (217), a bevel gear system (218) and a comb brush shaft (219), the bottom of the comb brush shaft (219) is rotatably connected to the other end of the lower mounting plate (206), the top of the comb brush shaft (219) is rotatably connected to the other end of the upper mounting plate (205), the upper end of combing shaft (219) is connected to the output shaft of the comb brush motor (217) via the bevel gear system (218); the comb brush motor (217) is connected to the upper mounting plate (205); the comb brush motor (217) drives the comb brush shaft (219) to rotate via the bevel gear system (218), the comb brush shaft (219) is fixedly connected to a plurality of comb brush rods (220), and the surface of the comb brush rod (220) is provided with a plurality of protrusions (2201).

8. The dual-mode switching platform integrating dry fruit detection and leaf screening fruit collection, as recited in claim 1, wherein: the bottom of the umbrella-type electric telescopic rod (301) is provided with a polyurethane buffer kit; the conveying mechanism (5) adopts an electric conveying mechanism; the conveying mechanism (5) is connected to the frame body (1) via the front support column (501), and to the bottom of the inner side of the fruit collection box (4) via the rear support column (502).

9. The dual-mode switching platform integrating dry fruit detection and leaf screening fruit collection, as recited in claim 1, wherein: further comprising a power supply, the umbrella-type electric telescopic rod (301), the walking motor (209) of the walking driving mechanism, the transmission motor (213) of the spindle rotation driving mechanism, the comb brush motor (217) of the comb brush module and the electric conveying mechanism of the conveying mechanism (5) are all electrically connected to the control box (221); the control box (221) is further used for controlling the action of the upper hydraulic telescopic rod (402) and the lower hydraulic telescopic rod (403); the umbrella-type electric telescopic rod (301), the walking motor (209) of the walking driving mechanism, the transmission motor (213) of the spindle rotation driving mechanism, the screw slider lifting mechanism (215) of the fruit monitoring module, the imaging sensor (216) of the fruit monitoring module, the comb brush motor (217) of the comb brush module, the electric conveying mechanism of the conveying mechanism (5) and the control box (221) are both electrically connected to the power supply.

10. An operation method based on the dual-mode switching platform integrating dry fruit detection and leaf screening fruit collection, as recited in claim 7, wherein: comprising the following steps:
Step 1, the frame body (1) moves to the vicinity of the target fruit tree (7), the two upper hydraulic telescopic rods (402) and the two lower hydraulic telescopic rods (403) act together to drive the left detection picking mechanism (2A) and the right detection picking mechanism (2B) to close, that is, the two upper comb brush chassis (201) are driven to close and the two lower comb brush chassis (202) are closed, and the fruit tree (7) is located between the two upper comb brush chassis (201) and the two lower comb brush chassis (202); and at the same time, the umbrella-type electric telescopic rod (301) in the left screening leaf collecting fruit mechanism (3A) and the right screening leaf collecting fruit mechanism (3B) is started, so that the bottom end of the umbrella-type electric telescopic rod (301) is attached to the surface of the trunk;
Step 2, the left detection picking mechanism (2A) and the right detection picking mechanism (2B) respectively perform the following steps:
Step 2.1, starting the spindle rotation driving mechanism, the spindle rotation driving mechanism driving the spindle (207) to rotate, so that the imaging sensor (216) in the fruit monitoring module faces the fruit to be detected on the fruit tree (7);
Step 2.2, starting the screw slider lifting mechanism (215), the screw slider lifting mechanism (215) driving the imaging sensor (216) to move up and down;
Step 2.3, the imaging sensor (216) collects the fruit surface image of the fruit tree (7) during the up and down sensor's movement, and sends the image information to the control box (221) in real time; the control box (221) performs analysis processing according to the received image information to determine whether the fruit needs to be picked; if so, step 2.4 is executed; otherwise, step 2.6 is performed;
Step 2.4, the control box (221) controls the spindle rotation driving mechanism to act, the transmission motor (213) of the spindle rotation driving mechanism drives the spindle (207) to rotate via the belt (214) so that the comb brush module faces the fruit to be picked in the fruit tree (7);
Step 2.5, starting the comb brush module, the comb brush motor (217) in the comb brush module driving the comb brush shaft (219) to rotate via the bevel gear system (218), thereby achieving fruit picking; and the picked fruit is rolled onto the conveying mechanism (5) from the umbrella-type electric telescopic rod (301), and the conveying mechanism (5) conveys the fruit to the fruit collection box (4); after the number of times that the trolley plate (208) moves back and forth along the guide rail (204) reaches a preset number of times, the picking process is ended, otherwise step 2.6 is executed;
Step 2.6, starting the walking driving mechanism, the walking driving mechanism driving the spindle (207), the fruit monitoring module and the comb brush module moving a preset distance along the guide rail (204) via the trolley plate (208), and after the movement ends, if the imaging sensor (216) has facing the fruit to be detected on the fruit tree (7), returning to execute step 2.2; and if the imaging sensor (216) does not face the fruit to be detected on the fruit tree (7), returning to step 2.1.
